(19) United States
(12) Patent Application Publication
(10) Pub. No.: US 2025/0342294 A1
(43) Pub. Date: Nov. 6, 2025

(54) Method for Efficient Thermal Simulation of Machinery or an Idling Vehicle with an Operating Cooling Fan

(71) Applicant: Dassault Systemes Americas Corp., Waltham, MA (US)

(72) Inventors: Huhu Wang, Dearborn, MI (US); Satheesh Kandasamy, Waltham, MA (US)

(21) Appl. No.: 18/653,155

(22) Filed: May 2, 2024

(51) Int. Cl. G06F 30/28

(52) U.S. Cl. CPC G06F 30/28

(57) ABSTRACT

A Computational Fluid Dynamics (CFD) thermal simulation model simulates thermal conditions in a flow field of idling stationary vehicle during operation of a cooling fan. A first transient boundary seeding (TBS) box is defined around the cooling fan in the CFD model. A first stage simulation run of the CFD model records transient flow information. The cooling fan is removed from the TBS box for a second stage simulation run seeded with the transient flow information from the first stage simulation run.

### FIELD OF THE INVENTION

The present invention relates to simulation, process automation, product design, and computational geometry, and more particularly, is related to simulating thermal flows for a running machine.

### BACKGROUND OF THE INVENTION

Computational Fluid Dynamics (CFD) technique has been widely used in the automobile industry in vehicle design and validation stages aiming to reduce the cost spent on real-world physical tests, and to shorten overall product development timelines. In a typical thermal management CFD simulation, a cooling fan model is simulated to accurately resolve the complex flow of the vehicle under hood region in an internal combustion (IC) engine. Although there are a few simplified fan modeling methods using fan curve or moving reference frame (MRF), the output of these models is less accurate than directly resolving the flow around the fan with the actual fan model included in the simulation. However, despite previous techniques to reduce labor costs to prepare corresponding simulation case files, such a fan model generally has excessive computational costs.

The cost issue may not be readily apparent if the simulation mainly focuses predicting the transient cooing airflow behaviors in the under hood area or the surface temperatures of certain thermal-critical parts when the vehicle is at a relatively high speed. However, for a “key-off with fan-on thermal simulation” (the vehicle is at a stop position with engine turned on), the cost becomes be significantly higher for a Lattice Boltzmann based CFD solver than the case where the vehicle is moving so there is ram air to help with the thermal management. In contrast, in an idle with fan-on thermal simulation, the fan is the main driver for the flow. An appropriately finer meshing strategy results in a higher computational cost, along with a longer simulating time due to the hot air moving slower in an idle scenario compared to a moving vehicle, such that it takes longer for the heat to propagate throughout the system (where the thermal field “settles down” slower than the flow field).

Methods such as using a coarser mesh to model component surfaces may help reduce the computational cost and thus to improve the overall efficiency, but these sacrifice accuracy, and a grid independence study is usually required to quantify the accuracy penalty. A more accurate approach is a transient boundary seeding (TBS) method which utilizes a pre-recorded simulation to seed another simulation. In previous TBS implementations, a first run is executed to fully capture the turbulence and transient flow structure. These captured parameters are then used as a boundary condition in the second run, resulting in an up to 66% cost reduction without any accuracy loss. This method may succeed with aerodynamic CFD applications (where turbulence and transient flow structures play a significant role in determining static pressure distribution on a vehicle surface and thus affects the vehicle' drag and fuel economy). However, for a thermal management CFD run, accurately resolving the turbulence structures around vehicle components is less of importance. Instead, engineers focus on the surface temperatures of thermal-critical parts. For a stationary vehicle or heavy-duty machinery with slow involvement of the temperature field and lower air moving speed, the simulation time cannot be reduced merely by seeding a pre-recorded boundary condition with turbulence structures included. Therefore, there is a need in the industry to address the abovementioned shortcomings.

### SUMMARY OF THE INVENTION

Embodiments of the present invention provide a method for efficient thermal simulation of idling machinery with an operating cooling fan. Briefly described, the present invention is directed to a Computational Fluid Dynamics (CFD) thermal simulation model that simulates thermal conditions in a flow field of idling stationary vehicle during operation of a cooling fan. A first transient boundary seeding (TBS) box is defined around the cooling fan in the CFD model. A first stage simulation run of the CFD model records transient flow information. The cooling fan is removed from the TBS box for a second stage simulation run seeded with the transient flow information from the first stage simulation run.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principles of the invention.

FIG. 1 is a schematic diagram showing the overall workflow for performing a thermal idling simulation using TBS method.

FIG. 2 is a schematic diagram showing the cooling fan location of a vehicle.

FIG. 3 is a schematic diagram showing the setup of the TBS box which replaces the cooling fan.

FIG. 4 is a schematic diagram showing the downstream thermal components of a vehicle relative to the cooling fan which is typically on the upstream.

FIG. 5 is a schematic diagram showing varied TBS box setups for one or two cooling fans.

FIG. 6 is a schematic diagram showing relative locations of upstream/front face, a TBS box, and a downstream/back face, and the overall mapping data flow direction.

FIG. 7 is a schematic diagram showing the shape detection method used for distinguishing between a rectangular and a circular TBS box which may have varied meshing conditions.

FIG. 8 is a schematic diagram showing the local coordinate system determination process for a rectangular TBS box case.

FIG. 9 is a schematic diagram showing the local coordinate system determination process for a circular TBS box case.

FIG. 10A is a schematic diagram showing a data grid created for resampling measurement data.

FIG. 10B is a schematic diagram showing a data grid created for creating a mapping table.

FIG. 11 is a flowchart indicating how the exemplary embodiments are incorporated into the previously established thermal CFD process.

FIG. 12 is a flowchart of an exemplary computer based method embodiment for simulating thermal conditions in a flow field of idling stationary motorized machinery during operation of a cooling fan configured to cool the machinery using a Computational Fluid Dynamics (CFD) thermal simulation model.

FIG. 13 is a schematic diagram illustrating an example of a system for executing functionality of the present invention.

FIG. 14A is a plot showing an exemplary 1D temperature mapping of a TBS box with two dummy heat sources located upstream of the TBS box.

FIG. 14B is a plot showing an exemplary 2D temperature mapping of the TBS box of FIG. 14A with two dummy heat sources located upstream of the TBS box.

### DETAILED DESCRIPTION

The following definitions are useful for interpreting terms applied to features of the embodiments disclosed herein, and are meant only to define elements within the disclosure.

As used within this disclosure a “mesh” refers to a representation of a modeled surface. A 3D mesh is the structural build of a three-dimensional model consisting of polygons. 3D meshes may use reference points in X, Y and Z axes to define shapes with height, width, and depth. A 3D mesh model is a 3D representation of an object. A meshing strategy refers to an approach of configuring mesh polygon shapes and sizes to efficiently and accurately represent a modeled surface.

As used within this disclosure, “Transient Boundary Seeding (TBS)” refers to a Computational Fluid Dynamics methodology designed to quickly assess vehicle aerodynamic performance during product development. TBS enables the usage of a reduced simulation domain without the loss of information from the omitted region. As aerodynamic flow is transient in nature, replacing a reduced domain with an average value boundary condition is insufficient because the unsteady behavior of the flow is lost. With Transient Boundary Seeding, the turbulence and transient flow structures are fully captured and added at the boundary of the simulated sub-domain, maintaining the same level of accuracy as a full vehicle simulation.

As used within this disclosure, Computational Fluid Dynamics (CFD) refers to a scientific discipline that applies software to produce quantitative predictions of fluid-flow phenomena based on the conservation laws (conservation of mass, momentum, and energy) governing fluid motion. A CFD solver refers to an application that uses CFD techniques to process a provided set of inputs.

As used within this disclosure, a “frame of reference” refers to a set of coordinates used to determine positions and velocities of objects in that frame. A Moving Reference Frame (MRF) refers to a frame of reference which moves with the observer along a trajectory (e.g., a curve).

As used within this disclosure, the Lattice Boltzmann Method (LBM) refers to a computational fluid dynamics (CFD) method for handling complex flow scenarios and intricate geometries. An LBM solver refers to an application that applies LBM to a provided set of inputs.

As used within this disclosure, “heavy machinery” refers to stationary or non-stationary machines powered at least in part by an electric motor or an internal combustion engine, for example (but not limited to) a motor vehicle (car or truck), an excavator, a bulldozer, a tractor, and a power generator.

As used within this disclosure, “Variable Resolution (VR)” refers to fluid regions defined by separate referencing geometries in which varied lattice refinement sizes among different levels are defined.

As used within this disclosure, a “thermal field” refers to a computational domain with temperature distributions.

As used within this disclosure, a “flow field” refers to a region of measurement in a fluid dynamics simulation of spatial distributions of flow variables such as velocity, pressure, turbulence information, amongst others. Here, a region admitting fluid (ingress region) may be defined as “upstream,” while a region emitting fluid (egress region) may be defined as “downstream,” for example upstream and downstream of a point of reference, such as a TBS box. A flow field is said to have settled when a moving average of a flow variable value of interest, for example velocity, stabilizes for the most of a period of time. A stabilization time window is usually 5 to 10% of the total simulation time. A sub-stabilization time window is usually 10 to 20% of the stabilization window.

As used within this disclosure, “sample surface measurement file” refers to a file created from a sample surface measurement. The file stores all fluid variable information measured by the sample surface during the simulation. The user typically configures which parameters are to be collected, and the file is generated automatically during the simulation period or at the end of the simulation by the CFD software.

Reference will now be made in detail to embodiments of the present invention, examples of which are illustrated in the accompanying drawings. Wherever possible, the same reference numbers are used in the drawings and the description to refer to the same or like parts.

The exemplary embodiments of the present invention solve the previously mentioned technical problems by:
Shortening a thermal simulation for an idling vehicle (or working stationary heavy-duty machinery) with a cooling fan by executing an automated TBS (“seeded”) workflow designed for thermal management applications
Replacing an actual fan model in the seeded TBS run to reduce simulation cost while maintaining overall accuracy
Optimizing the case setup for the TBS run to further reduce simulation cost
Automatically mapping scalar flow variables such as temperature from the front face/upstream of a TBS box to its back face/downstream to capture any temperature field change due to flow recirculation in the seeded TBS run
Reading a data structure of a modeled surface mesh file and return its vertices and triangle information
Analyzing a shape of the TBS box to be either rectangular or cylindrical box so that different mapping methods can be automatically applied
Processing the geometry information of the exported TBS upstream sampling surface and calculating its normal
Calculating the distance between the TBS upstream sampling surface and the TBS front/upstream face and determining the vector for the mapping direction
Establishing a local coordinate system (rectangular or cylindrical) on the downstream/back face of the TBS box
Establishing the local coordinate system in a consistent way that is independent of the orientation and location of the TBS box
Processing the generated sample surface measurement file during the simulation running process and extract the geometry and scalar fluid variables
Creating a table with a format which is readable to a CFD solver. The table includes the location of each data point and the corresponding scalar fluid variables
When creating the table for a cylinder shaped TBS box, extracting the data read from the sample surface measurement file in an efficient way so that only data falling within the boundary of the downstream/back face of the cylindrical TBS box are processed.
   Accordingly, the embodiments split a traditional and time-consuming thermal simulation for vehicle idling or stationary heavy-duty machinery working condition with cooling fan on into two stages. The first stage/run is for collecting signal flow around the cooling fan using a TBS box enclosing the cooling fan. In the second stage/run, the flow information collected at the TBS box surfaces is used as a boundary condition. The fan and corresponding finer variable resolution (VR) regions related to fan are removed. As a result, the simulation time is reduced.

An auto-stop feature in the first stage/run saves cost. Removing the cooling fan for the second stage run reduces the maximum expected velocity, further reducing the simulation time when using an LBM based solver. The embodiments support both single fan and multiple fan scenarios.

The embodiments automatically detect the shape of the TBS box enclosing the fan and execute corresponding downstream processes, obviating the need for a user to provide any shape information of the TBS box. The embodiments update scalar fluid variables at a downstream face of the TBS based on the upstream face variables, for either 1D or 2D mapping.

The embodiments first automatically export the appropriate geometry for mapping, including a prepared sample surface in front the TBS box and the TBS box itself. Then the embodiments perform a geometry analysis of two mesh files (corresponding to upstream/downstream surfaces of the TBS box) to calculate a local coordinate system located at the back/downstream face of the TBS box.

The embodiments produce a table in a format readable by a CFD solver application (for example, provided by the simulation environment application). For a cylindrical TBS box case, the embodiments implement a K-D tree data structure when searching the neighboring data points around a target data point, improving the computational efficiency.

In an exemplary embodiment, the methodology disclosed in the invention reduces an overall turnaround time for a CFD thermal simulation for an idling vehicle or a working stationary heavy-duty machinery with cooling fan on condition, for example, on the order of 30%. The embodiment may automatically distinguish between geometries of a 3D rectangular box and a cylindrical box. Further, the methodology may be implemented within an automated workflow to perform a 1D or 2D mapping of scalar fluid variables from one surface to another, the methodology may also used to efficiently create a data table with a form that is easily processed by a CFD solver.

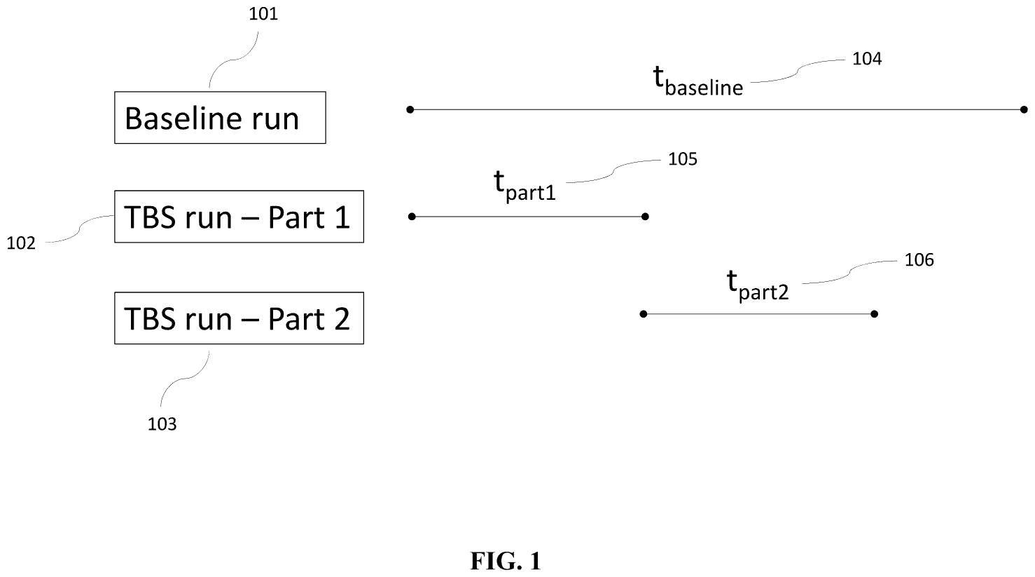

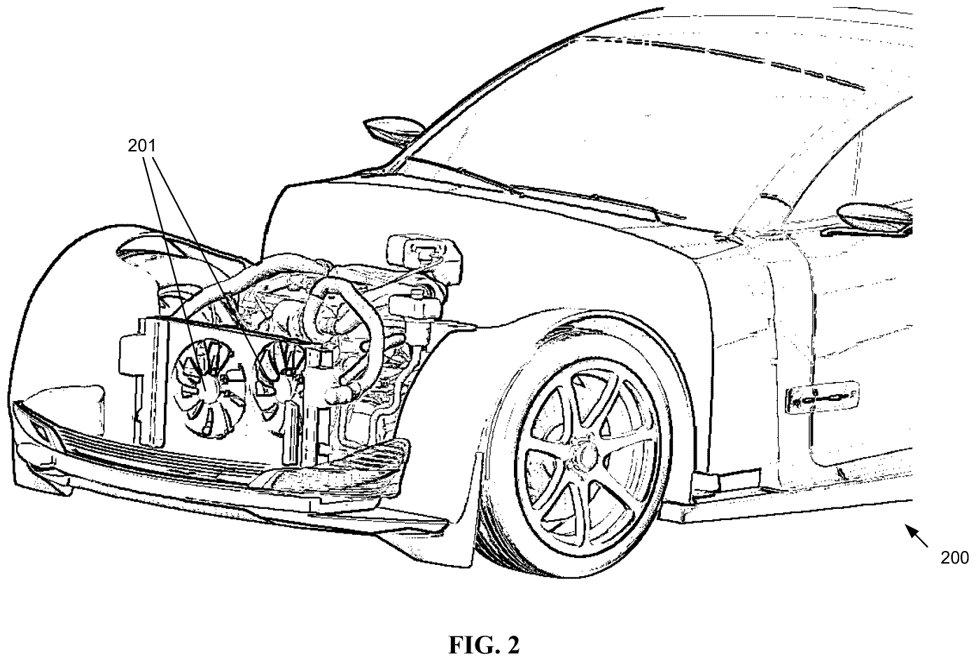

FIG. 1 shows an exemplary timeline for executing the workflow of a first and second part of a TBS run on a simulation of a vehicle 200 (shown in FIG. 2) under the first embodiment with respect to a “baseline” run 101 of previous methodologies. Here, the baseline thermal run 101 of an idling condition with fan on takes a physical simulation time t_{baseline} 104 to complete. The duration of t_{baseline} 104 may be long, for example up to one or more days, due to the presence of cooling fans 201 in the simulated vehicle 200 as shown in FIG. 2, where a thermal field needs a longer time than a flow field to settle down. The duration of t_{baseline} 104 may depend on the hardware and actual physical time duration specified for the simulation. To address this issue, the embodiments utilize the TBS method to split the process into two parts, a TBS run first part 102 and a TBS run second part 103. The first part 102 of the TBS run is a signal collecting step with an execution duration of tₚₐᵣₜ₁ 105.

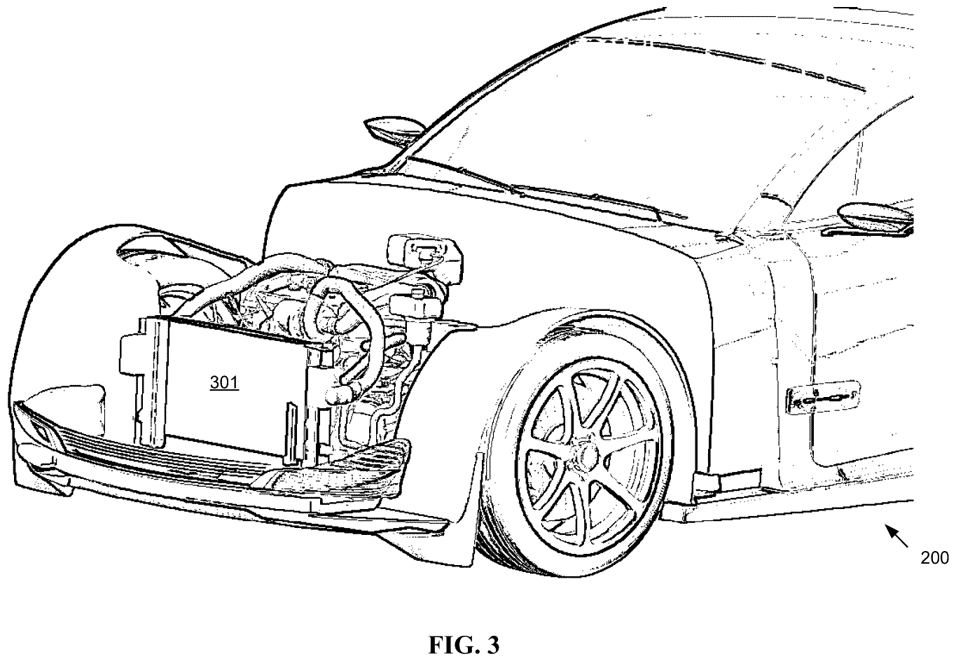

A bounding box 301 (also called TBS box) as shown in FIG. 3 is created and placed in the simulation model as a referencing geometry meaning that it will not actually interact with the fluid domain. For example, as shown in FIG. 3, the bounding box 301 may have a rectangular shaped profile surrounding the cooling fans 201. As described below, a cylindrical bounding box may alternatively have a circular shaped profile, for example, surrounding a single cooling fan. Fluid variables such as density, pressure, velocity, and turbulence information are collected using this TBS box 301 at an optimized frequency at this stage. The optimized frequency may be determined according to best practices developed by running multiple simulation for varied models to find a balanced/trade-off value between accuracy and the output measurement file size. In one embodiment, the duration tₚₐᵣₜ₁ 105 (FIG. 1) of the first part 102 of the TBS run may be a pre-defined fixed number, where the simulation is configured to stop at the end. Preferably, tₚₐᵣₜ₁ 105 is selected to ensure the flow field has settled before the end of the first part 102 of the TBS run. In another alternative embodiment, the simulation may be stopped automatically using a predetermined criteria, for example, by setting up a scalar fluid variable monitor (for example, as described by PowerFLOW® 2024 PowerCASE User's Guide, Dassault Systemes America Corp., Johnston, RI, USA) and dynamically evaluating the convergence of the signal.

In the Part 2 run 103 (FIG. 1), the cooling fans 201 (FIG. 2) are removed, and the TBS box 301 is changed to an inlet boundary condition from the TBS Box referencing geometry. This arrangement enables the seeding for the second part run 103 (the “seeded run”) to use the pre-recorded transient flow information. The total simulation time including tₚₐᵣₜ₂ 106 spent on the second part run 103 and tₚₐᵣₜ₁ 105 is shorter than t_{baseline} 104, for example, on the order of 30% shorter.

The TBS second part run 103 typically contributes more to the TBS run time than the auto-stop feature implemented in TBS first part run 102, because in a baseline run 101 with the presence of cooling fans 201, extra fine meshes or variable resolution (VR) regions need to be assigned to the fan region to fully resolve the flow structures, while these fine VR regions are removed in the seeded TBS second part run 103. The maximum expected velocity for an LBM solver affects the simulation time as well, since the maximum expected velocity is much lower in the TBS second part run 103, because the maximum expected velocity is usually a fan tip velocity, and fans are all removed in the second run. Eq. 1 shows the contribution from the finest mesh size or the mesh resolution per characteristic length and the maximum expected velocity to the simulated time in one timestep in an LBM solver for a coupled thermal and momentum simulation:

$$simulated time in one timestep = \frac{{k}_{1} \sqrt{\frac{charT}{max\_exp \_T}}}{\frac{resolution}{charL} * max\_exp \_V} \qquad ( Eq . 1 )$$

where k_1 is a constant with a value of 0.236403 for an external flow and 0.109109 for an internal flow. charT is the characteristic temperature in Kelvin. max_exp_T is the maximum expected temperature in Kelvin. resolution is the number of mesh elements or cells. charL is the characteristic length. max_exp_V is the maximum expected velocity. Eq. 1 indicates that to increase the simulated time in one timestep (so that the transient solver can march faster in time and thus to save the overall simulation time), the mesh density or resolution/charL and max_exp_V) should be reduced, which is the case in TBS Part 2 run 103.

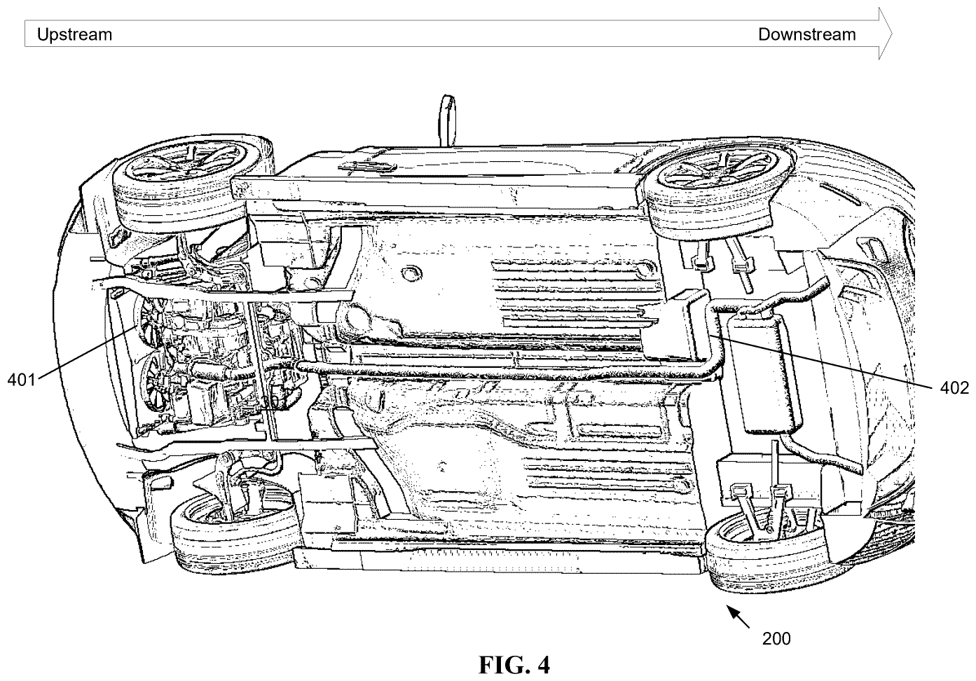

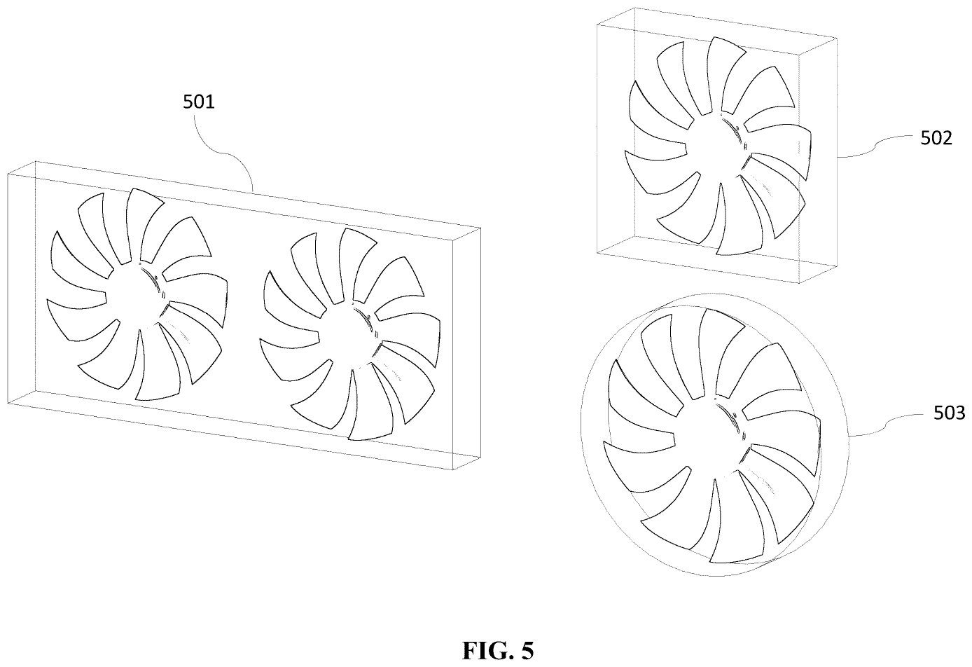

Under the exemplary embodiments, accuracy is not compromised significantly (if at all) with the TBS methodology compared with the baseline because the cooling fans 401 (FIG. 4) are usually located upstream of the flow field of the vehicle or heavy-duty machinery, while temperature sensitive components are generally downstream. For example, the temperatures of vehicle components around a hot exhaust system 402 may typically be highly affected by upstream flow conditions. These flow conditions in an idling or stationary condition is mainly determined by the driving force from the fans 201 (FIG. 2). Thus, recording periodic flows induced by the fans 201 (FIG. 2) using a TBS box 301 (FIG. 3) and then using the collected the flow information to seed the downstream flow field does not alter the original results, considering the temperature field takes longer to settle down (converge) in this periodic flow field. As shown by FIG. 5, either a rectangular TBS box shape 502 or a cylindrical TBS box shape 503 may be selected for a single-fan case, while a rectangular box 501 is usually utilized for two or more fans.

Although the auto-stop feature implemented in the invention in TBS run first part 102 may not contribute as much savings as the removal of cooling fans does in TBS second part run 103, in some scenarios the savings may be significant, for example, if the flow field “settles down” (converges) faster than expected before the run starts. Moreover, utilizing this automatic way to stop the simulation also reduces possible human errors and removes certain uncertainties caused by subjective opinions regarding when to declare the convergence of a signal. The embodiments may choose the air mass flow rate across the main radiator or heat exchanger as the signal parameter for monitoring the convergence. The signal algorithm utilized in the embodiments first determine the end of the initial transient period and then evaluate the signal to dynamically ensure the signal has been fully converged to statistically reliable mean value. The signal algorithm declares a convergence and thus stops the simulation when the cumulative running average calculated by Eq. 2 after the initial transient period is stabilized overall a stabilization time window. In addition, the gradient of the cumulative running average needs to be stabilized over a smaller sub-stabilization time window. The cumulative running average satisfies a desired confidence interval which can be, for example, the one standard deviation with a value of 68.3% or two standard deviation with a value of 95.4% depending on the accuracy requirement of a specific run.

$${S}_{avg} = \frac{1}{t - {t}_{0}} {\sum }_{t = {t}_{0}}^{t} signal [ i ] \qquad ( Eq . 2 )$$

where S_{avg} is the cumulative running average of a signal, and t is the current time, to is the time when the initial transient period ends.

Although the workflow described above works well in most scenarios, cases where are any new flow structures such as recirculation which affects some scalar fluid variables such as temperature may pose challenges. The new temperature change at the upstream before the TBS box is not passed to the downstream because that temperature should not be collected in the TBS first part run 102 and this is not used to seed the TBS second part run 103 as the temperature field takes longer to settle down. To resolve this issue, the embodiments implement an automatic workflow executed in the TBS second part run 103 to capture the condition happening at the upstream and map the information to the downstream. Specifically, for a thermal simulation, temperature is the scalar fluid variable that is mapped from upstream of the TBS box to the downstream.

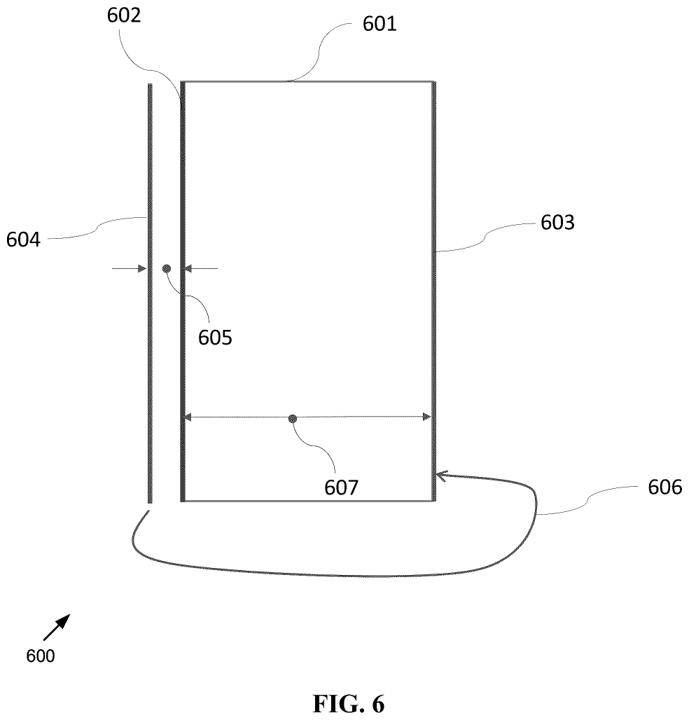

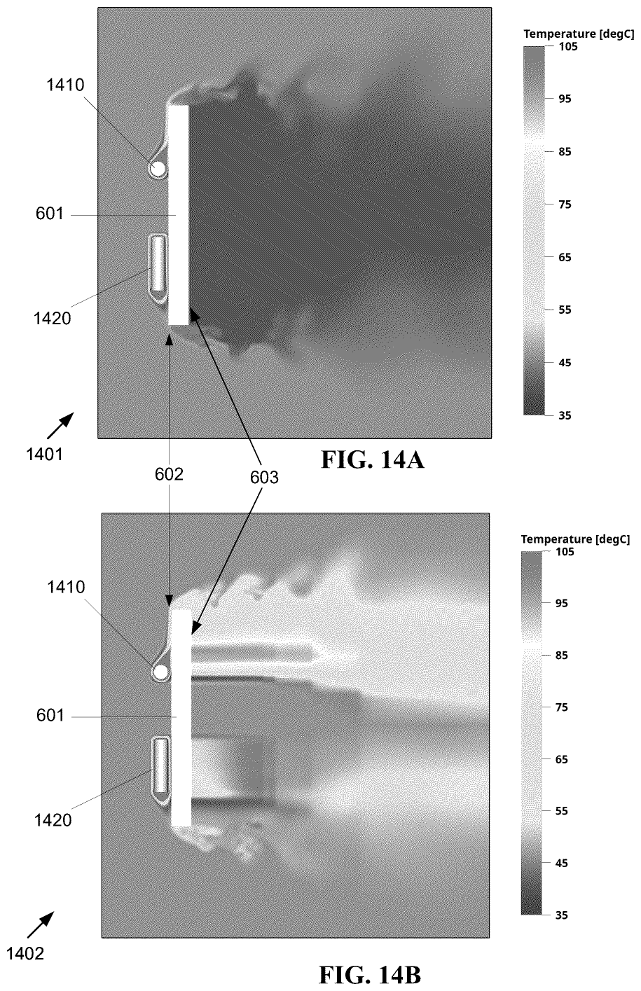

As shown by FIG. 6, a measurement surface 604 is placed in front of an upstream/front face 602 of the TBS box 601 with a small gap 605 to capture upstream temperature information, for example, but not limited to 0.5 mm to 1 mm. The temperature information stored for each measuring frequency in a measurement file during the simulation TBS second part run 103. The information is subsequently passed to the TBS box 601's downstream/back face 603 with the data flow direction 606. This temperature information is assigned as a surface boundary condition on face 603. The invention supports both one dimensional (1D) and two dimensional (2D) mapping. For the 1D mapping, the collected temperature information on face 604 is averaged and assigned to face 603. Although the 1D mapping is a simpler process than 2D mapping, 1D mapping suffers an accuracy issue when the temperature is not uniformly distributed on face 602. Thus, the workflow disclosed in the embodiments defaults to be a 2D mapping unless the user overwrites it with a simple Boolean input. For example, FIG. 14A shows a 1D mapping 1401 of the TBS box 601 with a first dummy heat source 1410 and a second dummy heat source 1420 located in front of the upstream/front face 602 of the TBS box 601, while FIG. 14B shows a 2D mapping 1402 of the TBS box 601 with the first dummy heat source 1410 and the second dummy heat source 1420 located in front of the upstream/front face 602 of the TBS box 601. As shown here, the 2D mapping of FIG. 14B shows greater temperature resolution downstream of the downstream face 603 than the 1D mapping of FIG. 14A.

For a 1D mapping of a TBX box 601, the shape of the TBS box 601 does not matter since a single value is assigned on the whole surface 604. However, for a 2D case, the mapping process is generally different for a rectangular TBS box 501, 502 and a cylindrical TBS box 503. To avoid implementing two workflows and asking the user to provide the shape information for the TBS box 601, the embodiments automatically detect the shape of the TBS box 601. Since there are two possibilities for the TBS box shape (rectangular and cylindrical), the embodiments just needed to distinguish between these two shapes. Instead of analyzing the 3D TBS box geometry, the embodiments perform an analysis of the geometry of the measurement surface 604, as this surface is indicative of the shape of the 3D TBS box 601. As a result, the analysis may be performed on a 2D basis since all elements of the measurement surface 604 are on the same plane.

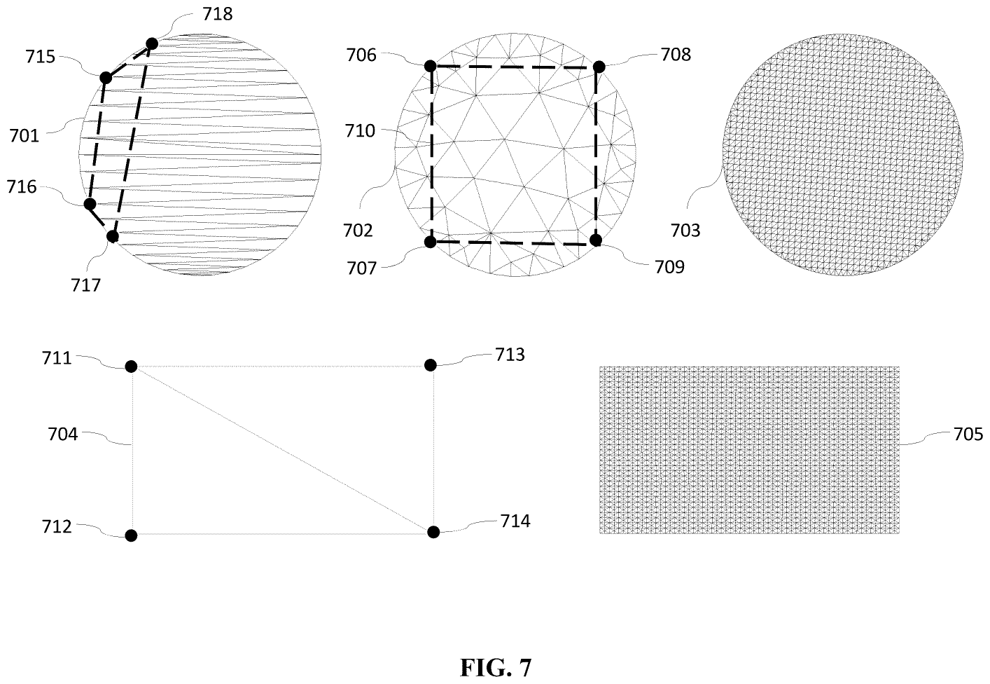

The measurement surface 604 mesh may have varied and/or unknown meshing conditions. For example, if the surface shape 604 is circular, then all vertices may be located at the edge as shown in 701 in FIG. 7 or the mesh can be coarse as per a second arrangement 702 or dense as per a third arrangement 703. Similarly, for a rectangular surface shape 604, the number of elements may be just two as per a fourth arrangement 704 or more than two elements as per arrangement five 705. To account for such uncertainties, the embodiments first calculate locations of four vertices having the largest distance from a center location for the measurement surface 604. The center location is determined by computing a mean of all vertices. For a TBS box having a cylindrical shape, the maximum distance from a point to the center is the radius of the circle, which is saved for future steps. For a circle of the first arrangement 701, vertices 706, 707, 708 and 709 are obtained. Here, these four points are all located on the edge since the maximum distance from the center is equal to the radius of the circle. These four vertices may or may not form a rectangle, as any vertices located on the circle edge might be picked. For example, in the first arrangement 701, vertices 715, 716, 717 and 718 form a normal quadrilateral. However, for a rectangle of the fourth arrangement 704, the four found vertices 711, 712, 713 and 714 are the only four vertices of the rectangle which meet the searching criteria. Thus, as the first round of the filtering process, the embodiments compute the edge vectors such as 710 using the obtained four vertices, and then checks the orthogonality of each edge pair. If all four edge pairs are not orthogonal, the shape is determined to be a circle. However, if all four edge pairs are found to be orthogonal and thus form a rectangle, then both shapes are possible as vertices such as 706, 707, 708 and 709 from a circular TBS box can form such a rectangle inside the circle. To further distinguish the shape under this scenario, the embodiments check if there are any vertices that are located outside this rectangle. For a circle, there must be vertices outside this rectangle as shown in 702. However, for a rectangle, no points are located outside the domain defined by the four vertices, as shown by the fourth arrangement 704. To check if any points are outside a rectangle, the embodiments first pick two adjacent edges of the rectangle as the basis vectors, for example [symbol] and [symbol] . The common vertex of these two edges is designated as the origin. Then all the vertices are iterated one by one, and the vector, denoted as [symbol] formed by each point and the origin is computed. Next [symbol] is projected onto both [symbol] and [symbol] . If any projected length is larger than either | [symbol] | and | [symbol] |, then this point is considered as outside the rectangle.

### 3.6.3.2 Translation Parameter Calculation

Once the shape of the TBS box 601 is determined, the embodiments determine a translation vector and distance. Ideally, the translation vector may be obtained directly from the normal of the measurement surface 604 if the CAD system user places the measurement surface 604 in a direction such that its positive normal points outward (leftward with respect to FIG. 6). However, the embodiments may not rely on this assumption. Instead, the embodiments first compute the normal of the measure surface 604 by choosing three non-collinear points (which form a triangle) and computing the normal vector of these points. The coordinates of this triangle (here denoted as triangleGlobal) are also returned for use as a global referencing triangle in subsequent steps.

Since this normal may or may not point towards the downstream/back face 603 and the location of the back face 603 is also unknown, a 3D geometry analysis of the TBS box 601 itself is performed. Here, a thickness 607 of the TBS box 601 is determined. Considering that the bounding box for an axial cooling fan has its minimum thickness along the fan's axial direction, the calculation of thickness 607 may be simplified to calculating the minimum thickness of the TBS box. All triangles of the TBS box mesh are iterated to establish a dictionary data structure with the keys the normal of each triangle and with the values of the coordinates of each triangle. The embodiments iterate over each normal, and the distances between any two normals or a normal pair are computed. The target TBS box minimum thickness 607 is the smallest distance among all calculated distances is. The corresponding triangle and normal pair is also returned for subsequent use. These two triangles, denoted as triangle1 and triangle2, are from the front face 604 and the back face 603. Respective distances between triangleGlobal and triangle1, and triangleGlobal and triangle2 are computed. The target translation distance (which is the one between measurement face 604 and the back face 603) is larger value between these two. The normal of the triangle corresponding to the larger distance from the back face 603 is then the translation vector, denoted as normalTranslateGlobal.

For purposes of efficient data management, it may be convenient to establish a local coordinate system on the destination surface to map information from one surface to another in 3D space. Specifically, for TBS mapping, the source face 604 and the destination face 603 are parallel, so the local coordinate systems on both source and destination faces only differ from each other by their origins. Thus, for example, the embodiments may first establish a local coordinate system on face 604 and then translate it to face 603 (or vice versa). Here, the geometry information of the measurement surface 604 is used as the input for this local coordinate system calculation. To create such a coordinate system, the location of the origin is determined. As a convention (and also as an assumption), the Z direction always points upwards when simulating a vehicle in a global coordinate system. Since the fan or cooling package may be located at the front, side or back area of a vehicle or heavy-duty machinery, the local coordinate system should be constantly located at the same location with the same orientation on the local surface to account for varied fan locations or orientations such as inclination. Additionally, the shape of the TBS box may play a role in how the local coordinate system is created. However, the Z direction assume holds valid under all these scenarios. Thus, the embodiments place the origin of the local coordinate system at the lowest Z location, although it is highly possible that two origin candidates may meet this criteria and thus extra steps may further remove the ambiguity.

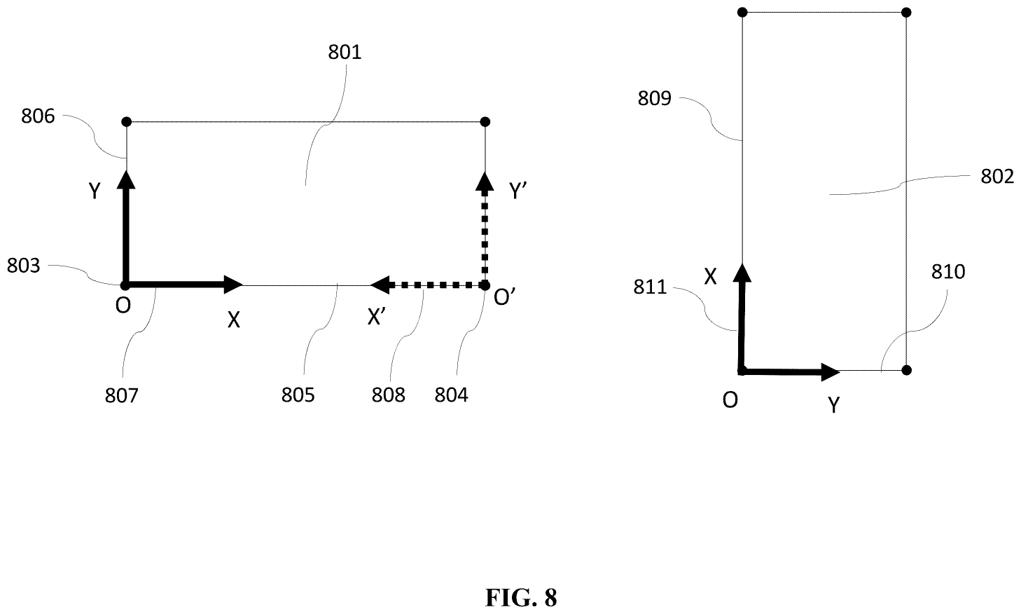

As shown in FIG. 8, For the rectangular TBS box case, the two bottom vertices 803 and 804 with the lowest Z values are the two candidates for the origin. To find these two points, the embodiments find all four vertices by calculating the distances from all points of measurement surface 604 mesh from its center and sorting this distance list. The embodiments select four vertices with the largest distance values. The four vertices are sorted based on their Z values, and two candidate bottom vertices 803 and 804 have the lowest Z values. The embodiments designate the longer side of the rectangle to be the X axis and the shorter side to be the Y axis. For example, for the horizontal layout 801 case, longer side 805 is the X axis and shorter side 806 is the Y axis. For the vertical layout 802 case, the X axis is along the longer side 809 and Y axis 810 is long. If the shape of surface 801 is square, any side may be chosen as the X axis as it does not matter or affect the mapping process due to its symmetry. A rule specifying the X and Y axes selection is based on the length of the side of a rectangle to make sure the location and the orientation of the generated local coordinate system is consistent regardless of the shape, location, and the orientation of the TBS box 701. This is important for an automated workflow when performing the data mapping.

Although this approach provides consistency, it may introduce some extra steps to fix the orientation of the local coordinate system. For example, the layout of the rectangle box becomes a variable that affects the orientation of the coordinate system. Following the same rules, a first coordinate system 807 for a horizontal layout is different from a second coordinate system 811 in a vertical layout. In addition, the previously mentioned two candidate origins 803 and 804 may originate two opposite coordinate systems such as OXY of the first coordinate system 807 and O′X′Y′ of a third coordinate system 808 in the horizontal layout 801. First, the embodiments anchor the local coordinate system to be placed where the first coordinate system 807 is located by comparing the Z vectors of the first coordinate system 807 and the third coordinate system 808 with the previously calculated global translation vector normalTranslateGlobal. According to the right-hand side rule, only the orientation of the first coordinate system 807 meets this criteria. As for the influence from the layout, the embodiments determine the layout of the rectangle so that a future mapping step may be conducted with appropriate indices along the X and Y axes. The embodiments calculate the distance between the two bottom vertices 803 and 804 and compare the width and height of the rectangle. The width and height are calculated in a step determining the longer and shorter side of the rectangle. The length of the longer side may designated to be the width value and shorter length may be designated to be the height. If the distance between the two bottom vertices 803 and 804 is equal to the height value, it means this rectangle is in vertical layout, and vice versa.

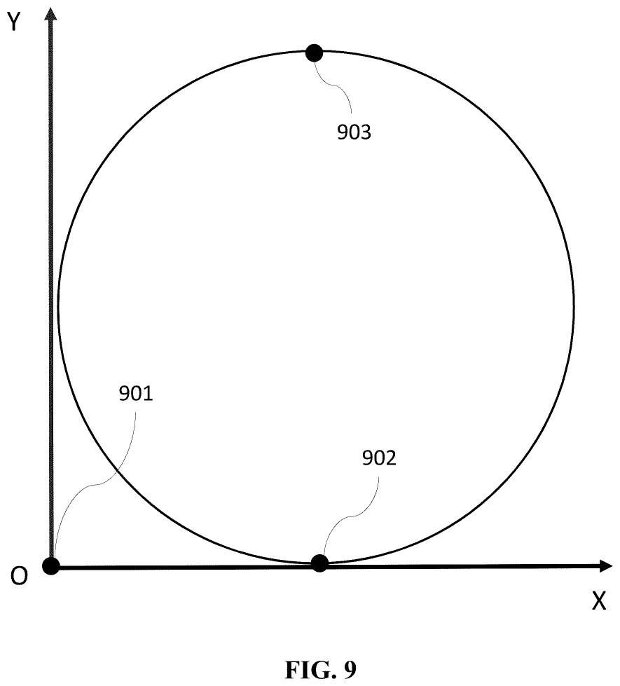

For the circular or cylindrical TBS box case 503 (FIG. 5), the embodiments establish a Cartesian coordinate system instead of using a cylindrical or polar coordinate system for simplified data exchange with the CFD solver and a friendlier user interface. As shown by FIG. 9, the origin 901 as shown in FIG. 9 is determined by calculating the mean of all points of the input geometry. Using the Z-up convention where the Z direction of the global/default coordinate system points upwards (towards the roof of the vehicle/machine's roof, the embodiments sort all points according to their global Z values and locates a top point 903 having the largest Z value and a bottom point 902 having the smallest Z value. Then the Y axis may be determined by calculating a vector between 903 and 902. The X axis is determined by calculating the cross product between the Y axis and the previously calculated global translation vector normalTranslateGlobal. The origin 901 is determined by translating the point 902 along −X direction by a distance equivalent to the circle radius which was previously calculated in the shape determination step.

Once a local coordinate system has been established on face 604 (FIG. 6), it is translated to face 603 (FIG. 6) using the previously calculated translation distance and normal. All these steps are executed before the simulation is running as pre-processing steps. The information of the local coordinate system on back face 603 (FIG. 6), the shape of the TBS box, the layout of the measurement surface 604 (FIG. 6), the width and height or the radius are saved in a text file for future usage when the simulation is running during which the data mapping also happens.

Once the simulation starts, a file of measurements sampled on face 604 (FIG. 6) is created. The embodiments process the file and save the results in a dictionary data structure. The keys are coordinates of each data point with respect to the global coordinate system. The values are the temperatures at each point. An example of such data structure is show by Table 1:

TABLE 1

| Key | Temperature |
|---|---|
| (−426.002, 10.0, 434.0) | 72.2 |
| (−426.002, −58.0, 566.0) | 69.8 |
| (−426.002, −50.0, 374.0) | 85.6 |

Finally, a mapping table is prepared which contains the data saved in the dictionary but with a different format for the CFD solver to read and process the data more efficiently while the simulation is running. To achieve the efficiency requirement, the coordinates of the data points are translated from the global one to the local one that was previously created for the back face 603 using Eq. (3):

$$[ \begin{matrix}{P}_{x}^{′} \\ {P}_{y}^{′} \\ {P}_{z}^{′}\end{matrix} ] = T ( [ \begin{matrix}{P}_{x} \\ {P}_{y} \\ {P}_{z}\end{matrix} ] - [ \begin{matrix}{O}_{x} \\ {O}_{y} \\ {O}_{z}\end{matrix} ] ) \qquad ( Eq . 3 )$$

where P′ᵢ(i=x, y, z) is the translated point coordinate with respect to the local coordinate system, Pᵢ(i=x, y, z) is the input point global coordinate, Oᵢ(i=x, y, z) is the origin of the local coordinate system, T is the transformation matrix computed using Eq. (4):

$$T = [ \begin{matrix}{u}_{x} & {u}_{y} & {u}_{z} \\ {v}_{x} & {v}_{y} & {v}_{z} \\ {w}_{x} & {w}_{y} & {w}_{z}\end{matrix} ] [ \begin{matrix}1 & 0 & 0 \\ 0 & 1 & 0 \\ 0 & 0 & 1\end{matrix} ] \qquad ( Eq . 4 )$$

where uᵢ, vᵢ, and wᵢ (i=x, y, z) are the basis vectors of the local coordinate system.

An example of the table format utilized in the invention for feeding the data to the CFD solver is shown by Table 2:

TABLE 2

| 1^{st} data point | 2^{nd} data point | |
|---|---|---|
| index dimension | index dimension | Temperature Value |
| 0 | 0 | 52.45 |
| 0 | 1 | 52.45 |
| 0 | 2 | 55.9 |
| 0 | 3 | 55.9 |
| 0 | 4 | 60.17 |
| . | . | . |
| . | . | . |
| . | . | . |
| 1 | 0 | 54.45 |
| 1 | 1 | 54.45 |
| 1 | 2 | 55.6 |
| 1 | 3 | 53.9 |
| 1 | 4 | 70.5 |

In contrast with the previously saved dictionary data structure in which the coordinates of each point is explicit, the table data only saves the indices of each dimension of each point with the starting and ending index as well as the spacing saved in the header portion of the file. Although it may be more efficient to interact with the CFD solver, the CFD requires a resampling of the data read from the measurement file as the read data may not be uniformly distributed depending on user setups, and the location of each data point may not match to those reported in the table.

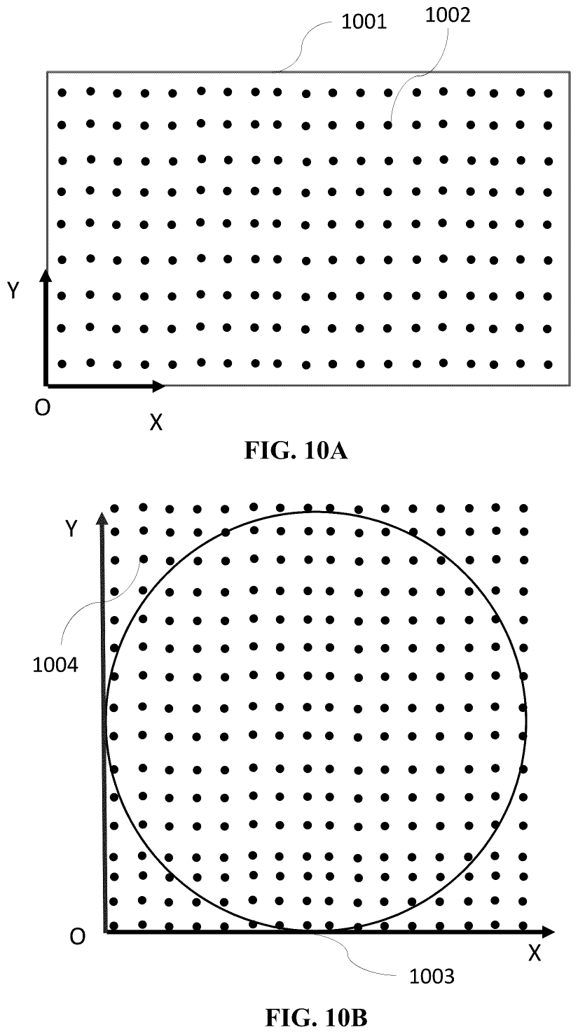

To perform the resampling, the embodiments first create a uniform grid layout as shown in FIGS. 10A-B. For example, for a rectangle 1001 shown in FIG. 10A, a data grid 1002 has the same dimension of the rectangle. For the case of a circle 1003 as shown in FIG. 10B, the diameter of the circle is used to create the grid. As a result, some of the grid points are located outside the circle. Thus, when resampling the measurement data onto these grid, the embodiments set up a mask circle with the same dimension of the measurement face 604 using the circle equation so that only the grid points which falls within the circle are eligible for receiving the data. Extrapolation is used when performing the data sampling. The embodiments implement a k-D tree data structure when searching for neighboring points for a given point in the data sampling process, which improves overall efficiency. The table is created whenever a new measurement file is written and read by the CFD solver to update the back face 603 (FIG. 6) so that the information indicated at the upstream can be passed and propagated to the downstream in the seeded TBS simulation.

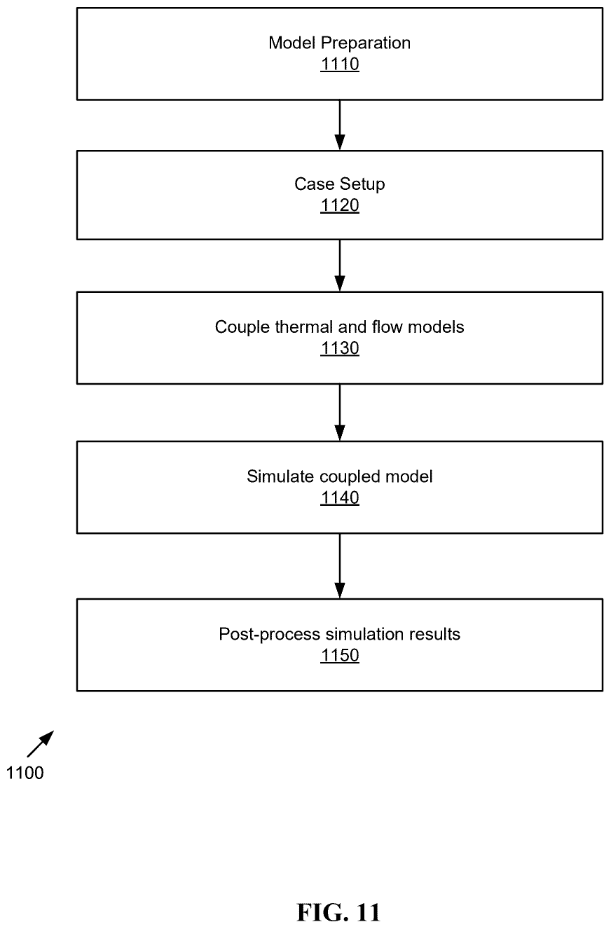

FIG. 11 is a flowchart 1100 indicating how the exemplary embodiments may be incorporated into the previously established thermal CFD process. It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

The model preparation step is unchanged from previous thermal CFD processes, as shown by block 1110. The case setup incorporates elements of the present embodiments, as shown by block 1120. The thermal and flow models are coupled as shown by block 1130. The coupled model incorporating the present embodiments is simulated, as shown by block 1140. The simulation results are post-processed, as shown by block 1150.

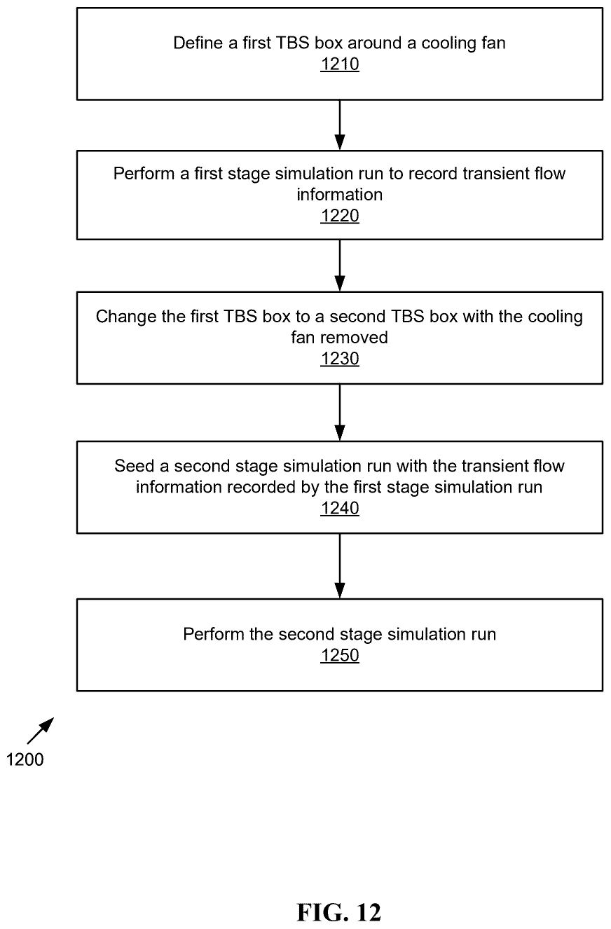

FIG. 12 is a flowchart 1200 of an exemplary computer based method embodiment for simulating thermal conditions in a flow field of idling stationary motorized machinery during operation of a cooling fan configured to cool the machinery using a Computational Fluid Dynamics (CFD) thermal simulation model. A first transient boundary seeding (TBS) box is defined around a cooling fan in the CFD model, as shown by block 1210. A first stage simulation run is performed with the CFD model to record transient flow information, as shown by block 1220. The cooling fan is removed from the CFD model, and a second TBS box replaces the first TBS box, as shown by block 1230. The second TBS box has an upstream face and a downstream face located according to a referencing geometry of the first TBS box. A second stage simulation run is seeded with the transient flow information recorded by the first stage simulation run, as shown by block 1240. The second stage simulation is run with the CFD model, as shown by block 1250.

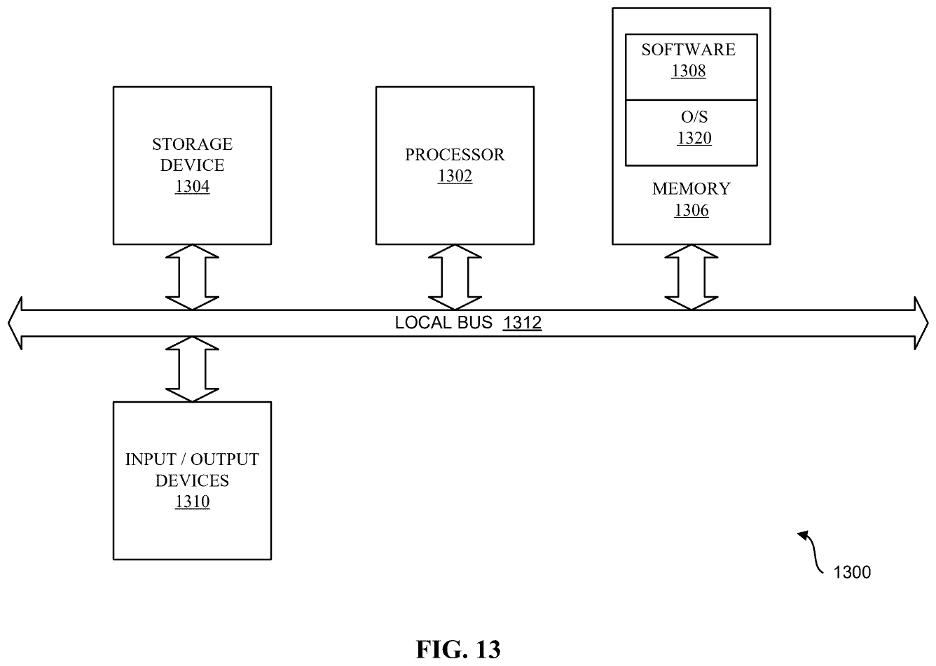

The present system for executing the functionality described in detail above may be a computer, an example of which is shown in the schematic diagram of FIG. 13. The system 1300 contains a processor 1302, a storage device 1304, a memory 1306 having software 1308 stored therein that defines the abovementioned functionality, input, and output (I/O) devices 1310 (or peripherals), and a local bus, or local interface 1312 allowing for communication within the system 1300. The local interface 1312 can be, for example but not limited to, one or more buses or other wired or wireless connections, as is known in the art. The local interface 1312 may have additional elements, which are omitted for simplicity, such as controllers, buffers (caches), drivers, repeaters, and receivers, to enable communications. Further, the local interface 1312 may include address, control, and/or data connections to enable appropriate communications among the aforementioned components.

The processor 1302 is a hardware device for executing software, particularly that stored in the memory 1306. The processor 1302 can be any custom made or commercially available single core or multi-core processor, a central processing unit (CPU), an auxiliary processor among several processors associated with the present system 1300, a semiconductor based microprocessor (in the form of a microchip or chip set), a microprocessor, or generally any device for executing software instructions. While FIG. 13 shows the processor as a single unit, alternatively the processor may include two or more processing units distributed across two or more locations, for example, communicating via a communication network in addition to or in place of the local interface 1312.

The memory 1306 can include any one or combination of volatile memory elements (e.g., random access memory (RAM, such as DRAM, SRAM, SDRAM, etc.)), volatile memory elements (e.g., a hard drive, a solid state drive (SSD), a flash drive, an optical drive, tape) and nonvolatile memory elements (e.g., ROM, CDROM, etc.). Moreover, the memory 1306 may incorporate electronic, magnetic, optical, holographic, and/or other types of storage media. Note that the memory 1306 can have a distributed architecture, where various components are situated remotely from one another, but can be accessed by the processor 1302.

The software 1308 defines functionality performed by the system 1300, in accordance with the present invention. The software 1308 in the memory 1306 may include one or more separate programs, each of which contains an ordered listing of executable instructions for implementing logical functions of the system 1300, as described below. The memory 1306 may contain an operating system (O/S) 520. The operating system essentially controls the execution of programs within the system 1300 and provides scheduling, input-output control, file and data management, memory management, and communication control and related services.

The I/O devices 1310 may include input devices, for example but not limited to, a keyboard, mouse/trackpad, haptic sensor, touchscreen, scanner, microphone, barcode reader, QR code reader, etc. Furthermore, the I/O devices 1310 may also include output devices, for example but not limited to, a printer, display (2D, 3D, virtual reality headset), transducer, etc. Finally, the I/O devices 1310 may further include devices that communicate bidirectionally via both inputs and outputs or a combined interface such as a full duplex serial bus (for example, a universal serial bus (USB)), for instance but not limited to, an interface for accessing another device, system, or network), a wireless transceiver, a copper, optical or wireless telephonic interface, a bridge, a router, or other device. The outputs may include an interface to control a manufacturing device, such as a 3D printer, a computerized numerical control (CNC) machine, and/or a milling machine, among others.

When the system 1300 is in operation, the processor 1302 is configured to execute the software 1308 stored within the memory 1306, to communicate data to and from the memory 1306, and to generally control operations of the system 1300 pursuant to the software 1308, as explained above.

The embodiments have several advantages over existing solutions. The embodiments reduce the computational time for a thermal simulation while maintaining overall accuracy by employing a two-stage TBS method. The embodiments support mapping the scalar fluid variables from the upstream/front face of the TBS box to its downstream/back face, accurately captures thermal condition near the TBS front/upstream face due to possible flow recirculation in the seeded run. Previously, any new thermal conditions at the upstream of the TBS box during the seeded run would not be captured. The auto-stop feature of the TBS first stage run reduces computational time of the simulation if the flow field settles down earlier than the pre-defined maximum simulation time. Automatic detection of the TBS shape eliminates otherwise needed user interaction, enhancing the user experience. The embodiments automatically establish a local coordinate system at the TBS downstream/back face which replaces an otherwise manual process. This local coordinate system is placed at the lower left corner of the target face when this face is viewed from the opposition direction of its normal or from its front side, enabling this coordinate system to be consistent when the cooling package or fan is inclined or placed at any location of the vehicle or heavy-duty machinery. The embodiments utilize a K-D tree data structure when outputting the table readable to the solver for the cylindrical TBS box case to improve the executing speed.

While the aforementioned embodiments are directed to an idling vehicle, the exemplary method may be applied in other scenarios as well, for example, but not limited to stationary heavy-duty machinery. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A computer based method using a Computational Fluid Dynamics (CFD) thermal simulation model for simulating thermal conditions in a flow field of idling stationary motorized machinery during operation of a cooling fan configured to cool the machinery, comprising steps of:
defining a first transient boundary seeding (TBS) box around the cooling fan in the CFD model;
performing a first stage simulation run of the CFD model to record transient flow information;
removing the cooling fan from the CFD model;
changing the first TBS box to a second TBS box comprising an upstream face and a downstream face located according to a geometry referencing the first TBS box;
seeding a second stage simulation run with the transient flow information recorded by the first stage simulation run; and
performing the second stage simulation run with the CFD model,
wherein the upstream face comprises an ingress surface and the downstream face comprises an egress surface.

2. The method of claim 1, further comprising a step of:
in the CFD model, placing a measurement surface in front of an upstream/front face of the second TBS box,
wherein the measurement surface comprises a gap configured to capture upstream temperature information.

3. The method of claim 1, wherein the cooling fan is located upstream of a flow field of the machinery.

4. The method of claim 1, wherein the first stage simulation run collects fluid data for one or more fluid variables from the group of density, pressure, velocity, and turbulence.

5. The method of claim 1, further comprising a step of automatically terminating the first stage simulation run based on a predetermined termination criteria.

6. The method of claim 5, wherein the predetermined criteria comprises a simulation duration (tₚₐᵣₜ₁).

7. The method of claim 5, further comprising steps of:
configuring a scalar fluid variable monitor; and
evaluating a convergence of a simulation flow field signal with respect to the predetermined criteria,
wherein the predetermined criteria comprises a flow field signal convergence level.

8. The method of claim 1, further comprising mapping a scalar flow temperature variable from the upstream face to the downstream in the second stage simulation run.

9. The method of claim 1, further comprising analyzing a shape of the TBS box to determine whether the TBX box is rectangular or cylindrical.

10. The method of claim 1, further comprising establishing a local coordinate system on the TBS box upstream face.

11. The method of claim 1, further comprising translating the local coordinate system from the TBS box upstream face to the TBS box downstream face.

12. The method of claim 1, further comprising:
generating a sample surface measurement file;
processing the sample surface measurement file to extract geometry and scalar fluid variables; and
creating a table including a location of each data point and corresponding scalar fluid variables,
wherein the table is readable by a CFD solver application.

13. The method of claim 1, wherein the stationary motorized machinery comprises a vehicle with a combustion engine.
